(19) United States
(12) Patent Application Publication
(10) Pub. No.: US 2026/0139747 A1
(43) Pub. Date: May 21, 2026

(54) ROTOR FOR MULTIWAY VALVE AND MULTIWAY VALVE INCLUDING THE SAME

(71) Applicant: HYUNDAI WIA Corporation, Changwon-si (KR)

(72) Inventor: Je Min YEON, Uiwang-si (KR)

(73) Assignee: HYUNDAI WIA Corporation, Changwon-si (KR)

(21) Appl. No.: 19/392,288

(22) Filed: Nov. 18, 2025

(30) Foreign Application Priority Data
Nov. 19, 2024 (KR) 10-2024-0164736

(51) Int. Cl. F16K 11/085

(52) U.S. Cl. CPC F16K 11/0853

(57) ABSTRACT

Disclosed are a rotor for a multiway valve and a multiway valve including the same. The rotor for a multiway valve includes a body including an upper surface, a lower surface, and a circumferential surface, a plurality of connection openings disposed on the circumferential surface of the body, at least one communication opening disposed on the circumferential surface of the body, a flow path connecting the plurality of connection openings to each other through the interior of the body, and a hole disposed on at least one of the upper surface of the body or the lower surface of the body so as to communicate with the at least one communication opening.

### CROSS-REFERENCE TO THE RELATED APPLICATION

The present application claims priority to and the benefit of Korean Patent Application No. 10-2024-0164736, filed on Nov. 19, 2024, in the Korean Intellectual Property Office, the entire disclosure of which is incorporated herein by reference.

### BACKGROUND

### 1. Field

The present disclosure relates to a rotor for a multiway valve and a multiway valve including the same.

### 2. Description of the Related Art

Generally, a multiway valve includes a rotor, a housing including a plurality of ports, and an actuator. The rotor includes a body, a plurality of openings disposed on a circumferential surface of the body, and a flow path connecting the openings to each other through the interior of the body. As the rotor is rotated by the actuator, the openings of the rotor may be selectively connected to the ports of the housing, thereby controlling a flow direction.

In the related art, among the plurality of openings, an opening not connected to the flow path is blocked to serve as a sealing portion. However, when the rotor rotates and the sealing portion passes by a port of the housing, the corresponding port may be momentarily blocked, which may cause cavitation in a fluid moving to a suction pump due to a pressure drop. This may cause noise and may reduce the durability of the suction pump.

### SUMMARY

An aspect of the present disclosure is to provide a rotor for a multiway valve and a multiway valve including the same, which are capable of solving the above-described problems.

A rotor for a multiway valve according to the present disclosure includes a body including an upper surface, a lower surface, and a circumferential surface, a plurality of connection openings disposed on the circumferential surface of the body, at least one communication opening disposed on the circumferential surface of the body, a flow path connecting the connection openings to each other through the interior of the body, and a hole disposed on at least one of the upper surface or the lower surface of the body so as to communicate with the communication opening.

The flow path may include an upper flow path connecting some connection openings of the connection openings to each other at a height close to the upper surface of the body and a lower flow path connecting other connection openings of the connection openings to each other at a height close to the lower surface of the body.

A sum of the height of the upper flow path and the height of the lower flow path may be equal to the height of the connection opening or the height of the communication opening.

The upper flow path and the lower flow path may have the same height.

The plurality of connection openings may include a first connection opening, a second connection opening, a third connection opening, a fourth connection opening, a fifth connection opening, a sixth connection opening, a seventh connection opening, an eighth connection opening, a ninth connection opening, and a tenth connection opening, and the flow path may include a first flow path interconnecting the first connection opening, the second connection opening, and the eighth connection opening at a height close to the upper surface of the body, a second flow path interconnecting the fourth connection opening and the sixth connection opening at a height close to the upper surface of the body, a third flow path interconnecting the third connection opening and the tenth connection opening at a height close to the lower surface of the body, and a fourth flow path interconnecting the fifth connection opening, the seventh connection opening, and the ninth connection opening at a height close to the lower surface of the body.

The at least one communication opening may include a first communication opening and a second communication opening.

The first communication opening may be disposed between the first connection opening and the second connection opening, and the second communication opening may be disposed between the ninth connection opening and the tenth connection opening.

A distance between the connection openings and communication opening may be less than the width of the connection opening and the width of the communication opening.

The connection openings and communication opening may be formed in the same shape.

The connection openings and communication opening may be formed to have the same height and the same width.

the p connection opening may include a first recessed portion recessed inward in the circumferential surface of the body in an area other than an area communicating with another connection opening through the flow path.

The first recessed portion may be formed in an arc shape.

The communication opening may include a second recessed portion recessed inward in the circumferential surface of the body.

The hole may include a first hole communicating with the second recessed portion of the first communication opening and a second hole communicating with the second recessed portion of the second communication opening.

The rotor may further include a partition wall configured to spatially separate the communication opening from the flow path, and the partition wall may be formed in an arc shape or a curved shape.

A multiway valve according to the present disclosure includes the rotor described above, a housing configured to accommodate the rotor and including a plurality of ports, and an actuator configured to rotate the rotor.

A space may be defined between the rotor and the housing so as to communicate with the hole in the rotor.

The hole may be formed in the upper surface or the lower surface of the body of the rotor, and a space may be defined between the housing and the upper surface or the lower surface of the body of the rotor to allow a fluid to be accumulated over a region from the communication opening to the space above or below the rotor.

A distance between the connection openings and communication opening of the rotor may be less than the width of the port of the housing.

The plurality of ports may include an inlet port and an outlet port, and a suction pump may be mounted to the outlet port.

The multiway valve may further include a seal disposed between the circumferential surface of the body of the rotor and the housing.

### BRIEF DESCRIPTION OF THE DRAWINGS

The accompanying drawings, which are incorporated in this specification, illustrate exemplary embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is an exploded view of a multiway valve according to an embodiment of the present disclosure;

FIG. 2A is a perspective view of a rotor of the multiway valve according to the embodiment of the present disclosure;

FIG. 2B is a front view of the rotor of the multiway valve according to the embodiment of the present disclosure;

FIG. 3 is a plan view of the rotor of the multiway valve according to the embodiment of the present disclosure;

FIG. 4 is a bottom view of the rotor of the multiway valve according to the embodiment of the present disclosure;

FIG. 5 is a cross-sectional view taken along line A in FIG. 2B; and

FIG. 6 is a cross-sectional view taken along line B in FIG. 2B.

### DETAILED DESCRIPTION OF EXEMPLARY EMBODIMENTS

A rotor 100 for a multiway valve and a multiway valve including the same according to embodiments of the present disclosure will be described in detail with reference to the accompanying drawings.

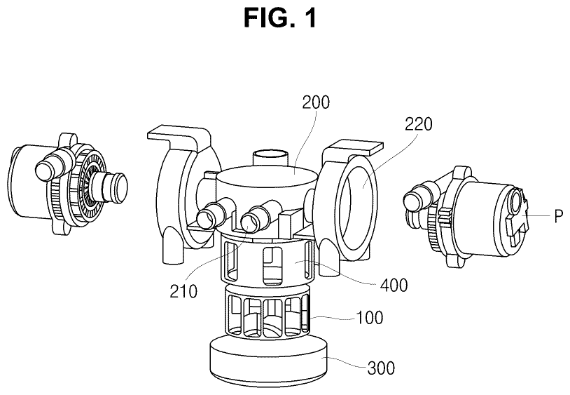

FIG. 1 is an exploded view of the multiway valve according to the embodiment of the present disclosure.

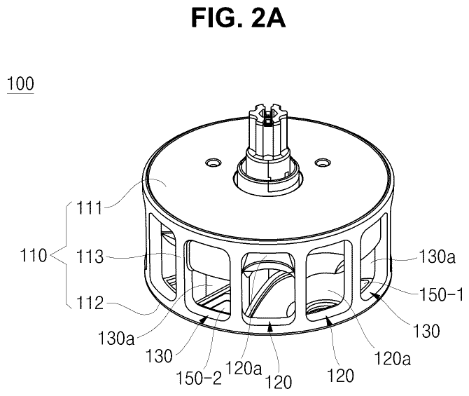

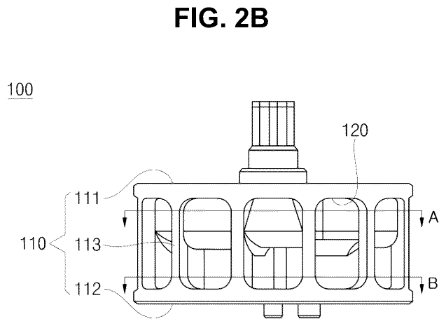

FIG. 2A is a perspective view of the rotor 100 of the multiway valve according to the embodiment of the present disclosure.

FIG. 2B is a front view of the rotor 100 of the multiway valve according to the embodiment of the present disclosure.

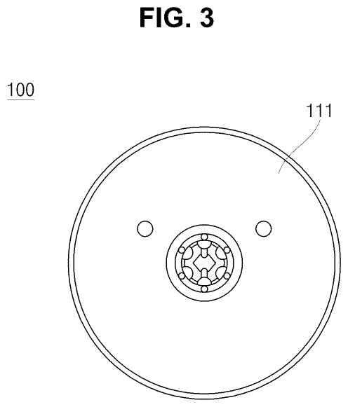

FIG. 3 is a plan view of the rotor 100 of the multiway valve according to the embodiment of the present disclosure.

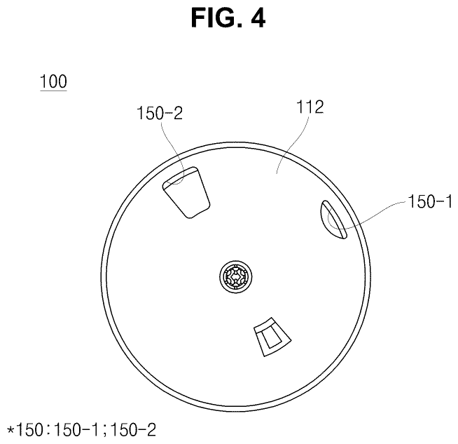

FIG. 4 is a bottom view of the rotor 100 of the multiway valve according to the embodiment of the present disclosure.

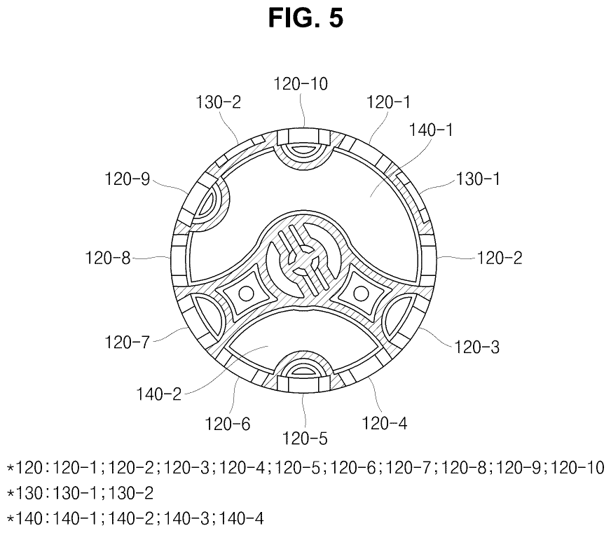

FIG. 5 is a cross-sectional view taken along line A in FIG. 2B.

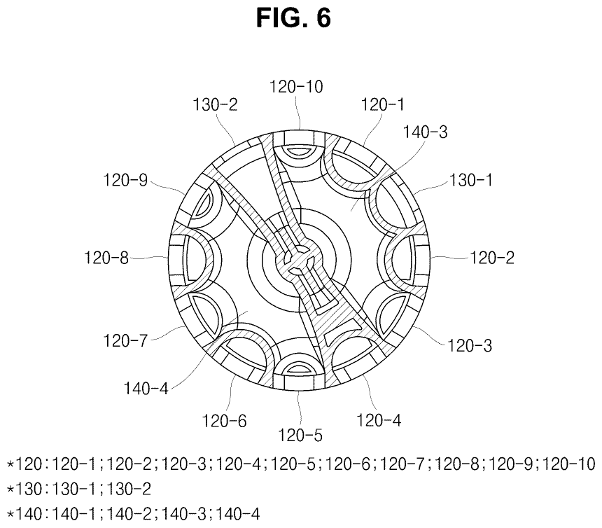

FIG. 6 is a cross-sectional view taken along line B in FIG. 2B.

Referring to FIG. 1, the multiway valve according to the embodiment of the present disclosure may include the rotor 100 and may include a housing 200, an actuator 300, and a seal 400.

Referring to FIGS. 2A to 5 together, the rotor 100 may include a body 110, a plurality of connection openings 120 formed in a circumferential surface 113 of the body 110, at least one communication opening 130 formed in the circumferential surface 113 of the body 110, a flow path 140 connecting the connection openings 120 to each other through the interior of the body 110, and a hole 150 formed in an upper surface 111 and/or a lower surface 112 of the body 110 so as to communicate with the communication opening 130.

The body 110 may be formed in a cylindrical shape and may include an upper surface 111, a lower surface 112 formed opposite the upper surface 111, and a circumferential surface 113 interconnecting the upper surface 111 and the lower surface 112.

Each of the upper surface 111 and the lower surface 112 may be separately formed in a disc shape and may be welded to a member forming the circumferential surface 113, the connection openings 120, the communication opening 130, and the flow path 140. In other embodiments, these components may be integrally formed as a whole. In the former case, the aforementioned member may be fabricated through injection molding, leading to high freedom of design.

The connection openings 120 may be disposed on the circumferential surface 113 of the body 110 and may be arranged in the circumferential direction of the body 110. As can be clearly seen from FIG. 2A, each of the connection openings 120 may include a first recessed portion 120a that is recessed inward in the circumferential surface 113 of the body 110 in an area other than an area communicating with another connection opening 120 through the flow path. The first recessed portion 120a may be formed in an arc shape. Therefore, a fluid may flow naturally and smoothly along the arc shape.

The connection openings 120 may be connected to each other through the flow path 140. For example, a fluid may move from one of the connection openings 120 to another connection opening 120 through the flow path 140.

Although ten connection openings 120 are illustrated in the drawings (see FIGS. 5 and 6), the number of connection openings 120 may be changed as needed.

Although the connection openings 120 are illustrated in the drawings (see FIG. 2B) as being formed in an approximately rectangular shape, the shape of the connection openings 120 may be changed as needed. For example, the connection openings 120 may be formed in a circular, elliptical, oblong, or polygonal shape.

It may be advantageous that all of the connection openings 120 be formed to have the same height and the same width. In other embodiments, if necessary, one of the connection openings 120 may be formed to have a height or a width different from that of the other connection openings 120.

As described above, the connection openings 120 may be variously designed as needed. In this embodiment, for convenience of description and understanding, the following description will be based on the structure shown in the drawings. In FIGS. 5 and 6, the connection opening located at the one o'clock position is referred to as a first connection opening 120-1, and the remaining connection openings sequentially arranged in the clockwise direction with respect to the first connection opening 120-1 are referred to as a second connection opening 120-2, a third connection opening 120-3, a fourth connection opening 120-4, a fifth connection opening 120-5, a sixth connection opening 120-6, a seventh connection opening 120-7, an eighth connection opening 120-8, a ninth connection opening 120-9, and a tenth connection opening 120-10.

The communication openings 130 may be disposed on the circumferential surface 113 of the body 110 and may be arranged in the circumferential direction of the body 110. As can be clearly seen from FIG. 2A, each of the communication openings 130 may include a second recessed portion 130a that is recessed inward in the circumferential surface 113 of the body 110.

The communication openings 130 may be spatially separated from the flow path 140. A partition wall that spatially separates the communication openings 130 from the flow path 140 may be formed in an arc shape or a curved shape. Therefore, a fluid may smoothly move around the partition wall.

Although two communication openings 130 are illustrated in the drawings (FIGS. 5 and 6), the number of communication openings 130 may be changed as needed.

Although the communication openings 130 are illustrated in the drawings (see FIG. 2B) as being formed in an approximately rectangular shape, the shape of the communication openings 130 may be changed as needed. For example, the communication openings 130 may be formed in a circular, elliptical, oblong, or polygonal shape.

It may be advantageous that the communication openings 130 be formed to have the same height and the same width as the connection openings 120. In other embodiments, if necessary, the communication openings 130 may be formed to have a height or a width different from that of the connection openings 120.

As described above, the communication openings 130 may be variously designed as needed. In this embodiment, for convenience of description and understanding, the following description will be based on the structure shown in the drawings. One of the two communication openings is referred to as a first communication opening 130-1, and the other thereof is referred to as a second communication opening 130-2.

A distance between the openings 120 and 130 described above may be less than the widths of the connection openings 120 and the communication openings 130. In some embodiments, the distance between the openings 120 and 130 may be less than the widths of ports 210 and 220 of the housing 200 to be described later.

The flow path 140 may connect the connection openings 120 to each other through the interior of the body 110.

The flow path 140 may include an upper flow path and a lower flow path. The upper flow path may connect some of the connection openings 120 to each other through the interior of the body 110 at a height relatively close to the upper surface 111 of the body 110. The lower flow path may connect the other connection openings 120 to each other through the interior of the body 110 at a height relatively close to the lower surface 112 of the body 110.

It may be advantageous that the height of the upper flow path be equal to the height of the lower flow path and that the sum of the height of the upper flow path and the height of the lower flow path be equal to the heights of the connection openings 120 and the communication openings 130.

In the drawings, a first flow path 140-1 interconnecting the first connection opening 120-1, the second connection opening 120-2, and the eighth connection opening 120-8 and a second flow path 140-2 interconnecting the fourth connection opening 120-4 and the sixth connection opening 120-6 are illustrated as the upper flow path (see FIG. 5), and a third flow path 140-3 interconnecting the third connection opening 120-3 and the tenth connection opening 120-10 and a fourth flow path 140-4 interconnecting the fifth connection opening 120-5, the seventh connection opening 120-7, and the ninth connection opening 120-9 are illustrated as the lower flow path (see FIG. 6). For example, the first communication opening 130-1 may be disposed between the first connection opening 120-1 and the second connection opening 120-2, and the second communication opening 130-2 may be disposed between the ninth connection opening 120-9 and the tenth connection opening 120-10.

This structure is merely one of various possible embodiments, and the present disclosure is not limited thereto. The form in which the plurality of connection openings 120 is connected to each other by the plurality of flow paths 140 may be modified as needed.

The hole 150 may be disposed on at least one of the upper surface 111 of the body 110 or the lower surface 112 of the body 110 so as to communicate with the communication openings 130.

The hole 150 is illustrated in the drawings as being formed in the lower surface 112 of the body 110.

Because two communication openings 130 are formed, two holes 150 are illustrated in the drawings as including a first hole 150-1 communicating with the second recessed portion 130a of the first communication opening 130-1 and a second hole 150-2 communicating with the second recessed portion 130a of the second communication opening 130-2.

For example, a fluid may move from the first communication opening 130-1 to a space below the body 110 through the first hole 150-1, and may also move from the space below the body 110 to the first communication opening 130-1 through the first hole 150-1. Likewise, a fluid may move from the second communication opening 130-2 to the space below the body 110 through the second hole 150-2, and may also move from the space below the body 110 to the second communication opening 130-2 through the second hole 150-2.

Referring again to FIG. 1, the housing 200 may serve to accommodate the rotor 100.

If the rotor 100 is mounted at a predetermined position in the housing 200, a space communicating with the holes 150 in the rotor 100 may be defined between the rotor 100 and the housing 200.

For example, if the holes 150 are formed in the upper surface 111 of the body 110 and if the rotor 100 is mounted at a predetermined position in the housing 200, the upper surface 111 of the body 110 may not be entirely in contact with the housing 200, and a space may be defined between the upper surface 111 of the body 110 and the housing 200. For example, a fluid may move from the communication openings 130 to the space above the rotor 100 through the holes 150 and may be accumulated in the space.

In other embodiments, if the holes 150 are formed in the lower surface 112 of the body 110 and if the rotor 100 is mounted at a predetermined position in the housing 200, the lower surface 112 of the body 110 may not be entirely in contact with the housing 200, and a space may be defined between the lower surface 112 of the body 110 and the housing 200. For example, a fluid may move from the communication openings 130 to the space below the rotor 100 through the holes 150 and may be accumulated in the space.

In still other embodiments, if the holes 150 are formed in the upper surface 111 and the lower surface 112 of the body 110 and if the rotor 100 is mounted at a predetermined position in the housing 200, a space may be defined between the upper surface 111 of the body 110 and the housing 200, and a space may also be defined between the lower surface 112 of the body 110 and the housing 200. For example, a fluid may move from the communication openings 130 to the spaces above and below the rotor 100 through the holes 150 and may be accumulated in the spaces.

The housing 200 may include a plurality of ports 210 and 220. For example, if six ports 210 and 220 are formed, the multiway valve of the present disclosure may function as a six-way valve. Some of the ports may serve as inlet ports 210, and the remaining ports may serve as outlet ports 220.

The widths of the ports 210 and 220 may be greater than the distance between the connection openings 120 and the communication openings 130 of the rotor 100. Regardless of the rotational angle of the rotor 100, at least one of the connection openings 120 or the communication openings 130 may remain at least partially connected to the ports 210 and 220.

The actuator 300 may be coupled to the rotor 100 to rotate the rotor 100.

Although the actuator 300 is illustrated in the drawings as being connected to the lower end of the rotor 100 and disposed concentrically with the rotor 100, the present disclosure is not limited thereto. For example, the actuator 300 may be connected to the upper end of the rotor 100 or may be disposed eccentrically with respect to the rotor 100.

The seal 400 may be disposed between the rotor 100 and the housing 200 to prevent a fluid from leaking through a gap between the circumferential surface 113 of the body 110 and the housing 200.

The seal 400 may be formed in a cylindrical shape. If the seal 400 is located at a position corresponding to the ports 210 and 220 of the housing 200, the seal 400 may be open to allow a fluid to pass therethrough, and if the seal 400 is located at a position not corresponding to the ports 210 and 220, the seal 400 may be closed.

Hereinafter, the operation of the multiway valve according to the embodiment of the present disclosure will be described based on the above-described structure.

As the rotor 100 is rotated by the actuator 300, the connection openings 120 of the rotor 100 may be selectively connected to the ports 210 and 220 of the housing 200, thereby determining a flow direction.

A suction pump P may be mounted to the outlet port 220 of the housing 200 in order to induce a flow of fluid.

In the related art, an opening not connected to the flow path is blocked to serve as a sealing portion. However, when the rotor rotates and the sealing portion passes by the outlet port of the housing, the outlet port may be momentarily blocked, which may cause cavitation in a fluid moving from the outlet port to the suction pump due to a pressure drop. This may cause noise and may reduce the durability of the suction pump.

In contrast, according to the present disclosure, a portion not connected to the flow path may serve as the communication opening 130 that communicates with the space above the rotor 100 and/or the space below the rotor 100 through the holes 150, rather than serving as a sealing portion, thereby allowing a fluid to be accumulated over an entire region from the communication opening 130 to the space above the rotor 100 and/or the space below the rotor 100.

For example, if the communication opening 130 (which corresponds to the sealing portion in the related art) passes by the outlet port 220 during rotation of the rotor 100, the fluid accumulated in the space above the rotor 100 and/or the space below the rotor 100 may be allowed to move to the outlet port 220 through the holes 150 via the communication opening 130, thereby ensuring flow continuity of the fluid moving from the outlet port 220 to the suction pump P. Such prevention of flow interruption may prevent the above-described cavitation.

Subsequently, if the rotor 100 further rotates and thus the communication opening 130 passes by or is connected to the inlet port 210, the fluid may move from the communication opening 130 to the space above the rotor 100 and/or the space below the rotor 100 through the holes 150 and may be accumulated again in the space.

For example, a reservoir may be mounted above the multiway valve, and a thermal management component may be mounted below the multiway valve. These components may be assembled into an integrated device. Because the thermal management component (such as a heat exchanger or an integrated reservoir) is capable of being connected through a port without using a separate branch pipe, it may be advantageous in terms of modularization of coolant-related components.

The rotor 100 for a multiway valve and the multiway valve including the same described above are merely one of various embodiments of the rotor for a multiway valve and the multiway valve including the same according to the present disclosure.

As is apparent from the above description, in the rotor for a multiway valve and the multiway valve including the same according to the present disclosure, a portion not connected to the flow path (which corresponds to the sealing portion in the related art) may serve as a communication opening that communicates with a space above the rotor and/or a space below the rotor through holes, thereby allowing a fluid to be accumulated over an entire region from the communication opening to the space above the rotor and/or the space below the rotor. Subsequently, if the communication opening passes by a port, the fluid may be allowed to move to the port through the communication opening, thereby ensuring flow continuity of the fluid moving to a suction pump. Such prevention of flow interruption may prevent the above-described cavitation.

Although the present disclosure has been described above with reference to the exemplary embodiments, the present disclosure is not limited thereto, and it should be understood that various changes and modifications can be made by those skilled in the art without departing from the spirit and scope of the disclosure as defined by the appended claims.

What is claimed is:

1. A rotor for a multiway valve, the rotor comprising:
a body comprising an upper surface, a lower surface, and a circumferential surface;
a plurality of connection openings disposed on the circumferential surface of the body;
at least one communication opening disposed on the circumferential surface of the body;
a flow path connecting the connection openings to each other through an interior of the body; and
a hole disposed on at least one of the upper surface or the lower surface of the body so as to communicate with the communication opening.

2. The rotor as claimed in claim 1, wherein the flow path comprises:
an upper flow path connecting some connection openings of the connection openings to each other at a height close to the upper surface of the body; and
a lower flow path connecting other connection openings of the connection openings to each other at a height close to the lower surface of the body.

3. The rotor as claimed in claim 2, wherein a sum of a height of the upper flow path and a height of the lower flow path is equal to a height of the connection opening or a height of the communication opening.

4. The rotor as claimed in claim 2, wherein the upper flow path and the lower flow path have the same height.

5. The rotor as claimed in claim 1, wherein the plurality of connection openings comprises a first connection opening, a second connection opening, a third connection opening, a fourth connection opening, a fifth connection opening, a sixth connection opening, a seventh connection opening, an eighth connection opening, a ninth connection opening, and a tenth connection opening, and
wherein the flow path comprises:
a first flow path interconnecting the first connection opening, the second connection opening, and the eighth connection opening at a height close to the upper surface of the body;
a second flow path interconnecting the fourth connection opening and the sixth connection opening at a height close to the upper surface of the body;
a third flow path interconnecting the third connection opening and the tenth connection opening at a height close to the lower surface of the body; and
a fourth flow path interconnecting the fifth connection opening, the seventh connection opening, and the ninth connection opening at a height close to the lower surface of the body.

6. The rotor as claimed in claim 5, wherein the at least one communication opening comprises a first communication opening and a second communication opening.

7. The rotor as claimed in claim 6, wherein the first communication opening is disposed between the first connection opening and the second connection opening, and the second communication opening is disposed between the ninth connection opening and the tenth connection opening.

8. The rotor as claimed in claim 1, wherein a distance between the connection openings and communication opening is less than a width of the connection opening and a width of the communication opening.

9. The rotor as claimed in claim 1, wherein the connection openings and communication opening are formed in the same shape.

10. The rotor as claimed in claim 1, wherein the connection openings and communication opening are formed to have the same height and the same width.

11. The rotor as claimed in claim 1, wherein the connection opening comprises a first recessed portion recessed inward in the circumferential surface of the body in an area other than an area communicating with another connection opening through the flow path.

12. The rotor as claimed in claim 11, wherein the first recessed portion is formed in an arc shape.

13. The rotor as claimed in claim 6, wherein the communication opening comprises a second recessed portion recessed inward in the circumferential surface of the body.

14. The rotor as claimed in claim 13, wherein the hole comprises:
a first hole communicating with the second recessed portion of the first communication opening; and
a second hole communicating with the second recessed portion of the second communication opening.

15. The rotor as claimed in claim 1, further comprising a partition wall configured to spatially separate the communication opening from the flow path, the partition wall being formed in an arc shape or a curved shape.

16. A multiway valve comprising:
the rotor as claimed in claim 1;
a housing configured to accommodate the rotor, the housing comprising a plurality of ports; and
an actuator configured to rotate the rotor.

17. The multiway valve as claimed in claim 16, wherein a space is defined between the rotor and the housing so as to communicate with the hole in the rotor.

18. The multiway valve as claimed in claim 16, wherein the hole is formed in the upper surface or the lower surface of the body of the rotor, and
wherein a space is defined between the housing and the upper surface or the lower surface of the body of the rotor to allow a fluid to be accumulated over a region from the communication opening to the space above or below the rotor.

19. The multiway valve as claimed in claim 16, wherein a distance between the connection openings and communication opening of the rotor is less than a width of the port of the housing.

20. The multiway valve as claimed in claim 16, wherein the plurality of ports comprises an inlet port and an outlet port, the outlet port being configured to allow a suction pump to be mounted thereto.

21. The multiway valve as claimed in claim 16, further comprising a seal disposed between the circumferential surface of the body of the rotor and the housing.
